(19) United States
(12) Patent Application Publication
(10) Pub. No.: US 2006/0108767 A1
(43) Pub. Date: May 25, 2006

(54) Power pedal for a bicycle

(76) Inventor: Rudolf Susko, Vancouver (CA)

Correspondence Address: RUDOLF SUSKO, 1110-1500 HOWE STREET, VANCOUVER, BC, V6Z 2N1, CA

(21) Appl. No.: 10/993,955

(22) Filed: Nov. 22, 2004

(51) Int. Cl. B62M 5/00; B62M 1/00

(52) U.S. Cl. 280/253

(57) ABSTRACT

A novel drive mechanism for a bicycle, featuring a scissor assembly defined by plurality of arms pivotally interconnected in an expandable sequence. The scissor assembly is attached pivotally to a frame on both sides and via a rigid slot attached pivotally to pedal cranks whereby permitting cranks oscillating motion. The cranks reciprocal oscillating motion is transferred by the assembly into a linear pulling force connected to a drive wheel axle, equipped with a freewheeling reel, by a flexible ligament spiraled in the reel. The efficiency of assembly's power transfer kinetics lessens required human force, in addition, the speed is substantially increased because the cranks motion is confined to the most efficient frontal segment of the 360-degree orbit whereby eliminating back-upward segment of the circular motion pedals.

### BACKGROUND OF THE INVENTION

This invention relates to a power-transmitting device for a vehicle. More specifically, the present invention relates to a new drive mechanism for transferring power from the pedals to the rear wheel of a bicycle.

The use of bicycle drive mechanisms is well known in the prior art. Bicycle drive mechanisms devised and utilized are known to consist of familiar, expected and obvious structural configurations. The prior art is crowded with numerous designs which have been developed for the fulfillment of countless objectives and requirements.

Known prior art bicycle drive mechanisms include U.S. Pat. No. 4,564,206; U.S. Pat. No. 6,749,211; U.S. Pat. No. 6,764,089; U.S. Pat. No. 6,779,807; and U.S. Pat. No. 6,783,139;

The objective of a conventional bicycle pedal configuration is to exert a pulling force to the endless chain by circular motion of the pedal lever. Pedals work on lever principle wherein the net lever arm is the difference between the pedal length and the radius of the driving sprocket. Improving this ratio for circular motion pedals is limited by the human leg anatomy. Circular motion of the pedal is further restricted by the number of revolution per minute that human can perform. The prior art is predominantly concerned in improving the easiness of ride using less human power, enhancing the speed and improving cumbersome complexity and maintenance. While these devices fulfill their respective, particular objectives and requirements, the aforementioned patents do not disclose features claimed by the present invention. In these respects, the drive mechanism according to the present invention substantially departs from the conventional concepts and designs of the prior art, and in so doing provide an apparatus primarily developed for a novel power transfer from the pedals to the rear wheel of a bicycle.

### SUMMARY OF THE INVENTION

The present invention comprises of a novel pedal mechanism defined by a scissor-type assembly. A pedal lever, being integral with the scissor-type assembly, is pivoted on the frame in a configuration enabling interconnected scissor-type units desired expansion and contraction. Two points of pivoted attachment to the frame include a fixed shaft, positioned on the frame in frontal relation to the powered wheel axle, and a slot disposed longitudinally from the shaft permitting slidable attachment. It further comprises a novel wheel driver defined by a freewheel reel coaxially engaged on the rear wheel axle. A linkage, for example a draw cable attached to the power pedal assembly, is spiraled in a single plane on the reel. Whereby the pedal assembly draw force causes wheel rotation by unwinding cable spiral from the reel. Pedal levers are arranged and confined to the most efficient front-downward segment of the 360-degree orbit and are reciprocally retracted to the upward position by retraction means including a pulley. The present invention does not preclude the use of a wheel hub transmission.

It is an object of the present invention to alleviate the human force requirements on the foot pedal by efficient transfer of the pedal lever force for powering the wheel.

It is another object of the present invention to improve substantially the speed of a vehicle/bicycle. The pedal slow motion is transmitted by the scissor-type units into a rapid pulling force enabling a substantial improvement in the speed—limited on the conventional circular motion pedals by achievable maximum rpm of the human force.

Still another object of the present invention is to eliminate cumbersome back-upward retracting portion of circular motion pedals and permitting only effective front-downward segment of the pedal lever rotation of less than 360-degree.

The pedal assembly is suitably sized and adapted for the use on existing bicycle-type frames without changing the rider position. It features simplicity, inexpensive design, eliminates unnecessary moving parts and thus lessens maintenance burden.

### BRIEF DESCRIPTION OF THE DRAWINGS

The invention, as exemplified by a preferred embodiment, is described with reference to the drawings in which:

FIG. 1 is a side view illustrating the power pedal applied on a bicycle.

FIG. 2 is a side view illustrating the power pedal in a retracted position.

FIG. 3 is a side view illustrating the power pedal in a depressed position.

### DESCRIPTION OF THE PREFERRED EMBODIMENTS

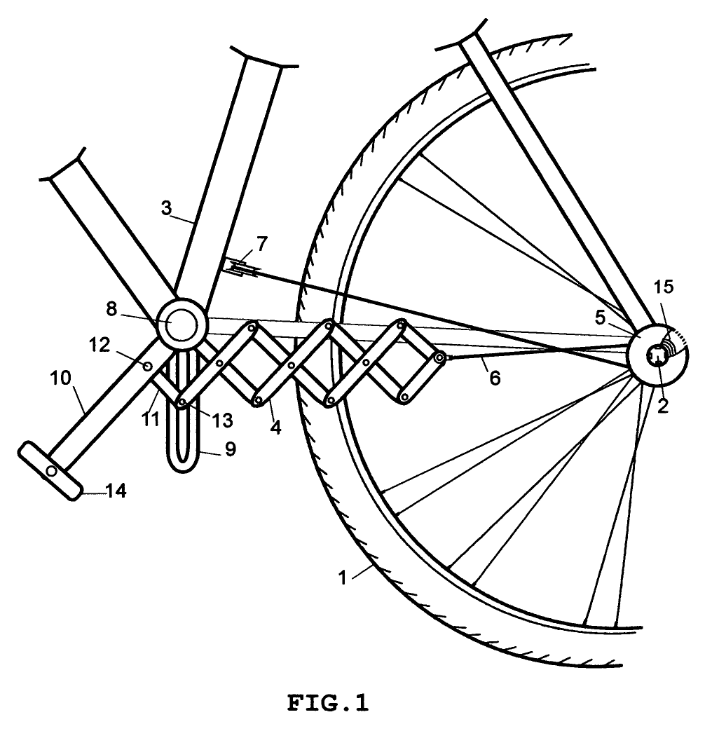

Referring now to the drawings and in particular to FIG. 1, one embodiment of the power pedal is illustrated on a bicycle. The omission of the detail definition and description of the bicycle does not preclude from the understanding of preferred embodiments. However, for the purpose of the present invention embodiments, a cycle-type vehicle includes at least two wheels from which one is a driven wheel 1 with an axle 2 and a frame 3. The frame 3 alternatively has supports or struts commonly provided on bicycles, or other desired structural members, etc.

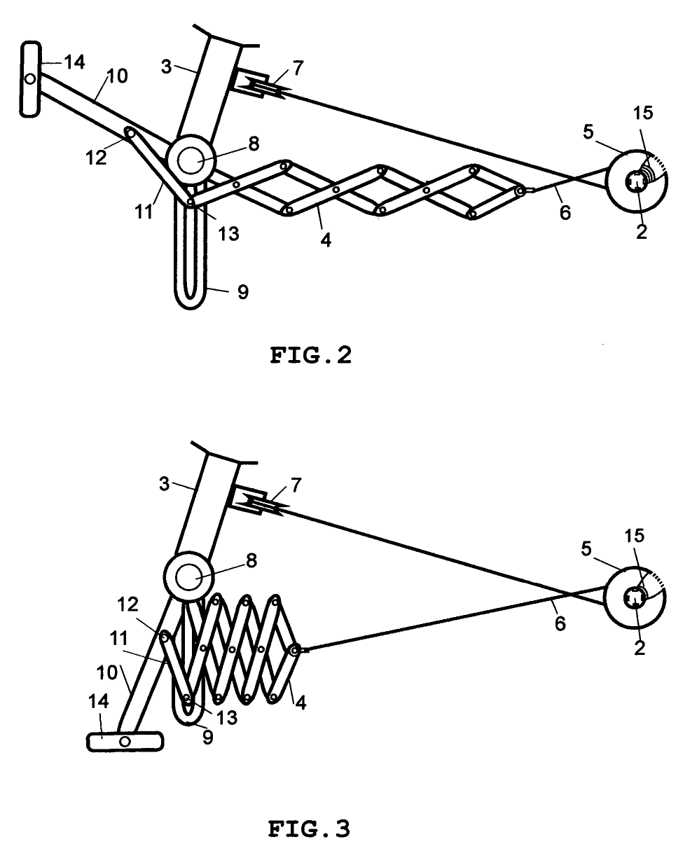

The preferred embodiments of the present invention include two scissor-type pedal assembly 4 positioned in a mirror image on both sides of the frame, although the illustrations refer mostly to one. The pedal assembly 4 is pivotally mounted on a stationary shaft 8 on both sides of the frame 3, more or less in the vicinity where the conventional pedals are mounted. Pedal assembly units are defined by pivotally interconnected flat rods in a scissor-like fashion being made preferably from a metal or metal alloy material. The size of assembly arms can be variable from unit to unit and arms are suitably sized for the engagement range between the shaft 8 and the wheel axle 2. For example, if the above-mentioned distance is 25 inches and each arm length is four inches then only six interconnected full units would suffice and a linkage 6 defined herein by a draw cable accounts for the difference, as shown in FIG. 2, for fully retracted pedal position.

The leverage of the pedal is given by the position of the fulcrum being integral with a pivot 12 where the first unit arm 10, defined by a pedal lever, is interconnected with he second arm 11. The leverage of the pedal lever 10, for example of 4:1, indicates that the human force on the foot pedal 14 is four times lesser than the force provided by the shaft 8 and the second arm pivot 13 on the draw cable 6. The second arm 11 is longer then the pedal lever 10 segment from the pivot 12 to the shaft 8. This arrangement makes the pivot 12 eccentrically positioned and its location determines the moving range of the pedal lever 10 from the upper retracted position as shown in FIG. 2 to fully depressed position as seen in FIG. 3. The front-downward segment of the 360-degree potential orbit around the shaft 8 is recognized to be the most efficient range. Pedal lever 10, constructed similar to the conventional bicycle pedal levers, is rotatably mounted on the stationary shaft 8 and includes conventional foot pedals 14 rotatably mounted thereon.

A slot 9 is rigidly welded at the bottom of the stationary shaft 8 enabling perpendicular slidable movements of the second arm pivot 13 engaged in the slot 9. Its length is determined by the size of engaging arms. Applied force on pedal 14 moves the pivot 13 away from the shaft 8 in the confinement of the slot 9, whereby the pedal assembly 4 scissor units are rapidly closing horizontally and drawing cable 6 as illustrated in FIG. 3. Alternatively, the slot 9 can be disposed from the stationary shaft 8 horizontally towards the wheel axle 2. In this configuration, the pivot 12 is integral with the shaft 8 and the middle pivot of the second unit is engaged slidably in the horizontally disposed slot 9.

A rotating driver 5, herein defined by a freewheel reel having capability of moving in one direction, is rotatably engaged on the wheel axle 2 on both sides of the wheel 1 and drives the wheel 1 one direction similar to the conventional sprocket system. The reel 5 is made preferably from a light, strong material like aluminum or other metal alloy or plastic. Width of the reel 5 is relatively narrow and dependent on the thickness of the cable 6 in order to fit only couple of single plane spirals 15 on the reel 5 hub.

The conventional circular motion pedals are disposed on each side in opposite direction. The manual power on the pedal is exerted on a front-downward portion of the cycle and the pedals are retracted by the back-upward motion. The present invention pedal levers 10 are both disposed in frontal direction for a front-downward reciprocal operation and front-upward reciprocal retraction. This arrangement eliminates the laborious back-upward retraction of the full cycle classic pedals.

Retraction means 7, as shown in FIG. 1, in the present embodiment is a pulley secured on the frame 3 enabling a reciprocal retraction of the pedal lever 10 on both sides of the frame by being engaged with cable 6 departing from each reel 5. Cable 6 is secured on the reel 5 hub and forms a double spiral configuration each oriented in opposite direction so that one end exits the reel 5 at the top for adjustable connection to the pedal assembly 4 and the other end exits the reel 5 at the bottom for engaging the pulley 7 as seen in FIG. 1. This arrangement provides an inverse rotation of respective freewheel reels 5 from each side of the wheel. Depressed pedal lever 10 on one side rotates the powered wheel in a predictable direction and causes inverse rotation of freewheel reel 5 on the other side and thus reciprocal upward retraction of respective pedal levers 10.

The actual length of cable 6 is determined by the distance from the last unit of fully depressed pedal lever 10, as illustrated in FIG. 3, on one side to fully retracted pedal in FIG. 2 on the other side and the required size of the spirals 15 diameter. This can easily be established by those skilled in the equipment-manufacturing field. Cable 6 is preferably made from a steel rope covered with plastic layer similar to a commonly used cable in pulley-type exercise equipment.

However, it should be appreciated that the present invention is expressly not limited to these embodiments. For instance, the retraction can be accomplished, in absence of the pulley 7, by a coil spring engaged on the reel 5 on both sides enabling independent pedal 10 movements and retraction. Furthermore the freewheel reel 5 can have a different configuration including an arrangement for various spiral 15 sizes and thus defining a transmission.

The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1-10. (canceled)

11. A drive mechanism for a bicycle having partially rotating pedal cranks, comprising:
a rigid slot being disposed longitudinally from a frame for slidable engagement;
a scissor assembly defined by plurality of arms pivotally interconnected in expandable sequence being attached pivotally to the frame and slidably to the rigid slot and via the slot being connected to the pedal cranks permitting the cranks rotating partially, whereby transferring the pedal cranks force into the linear pulling force; and
a flexible ligament connecting the scissor assembly to a driven wheel axle arranged for causing rotary motion of the wheel.

12. The drive mechanism of claim 11, being positioned on both side of the frame in mirror image includes a pulley mounted on the frame and engaged by the flexible ligament extending from the wheel axle from each side of the frame and thus causing reciprocal cranks movement.

13. The drive mechanism of claim 11, wherein the wheel axle includes a freewheeling reel and the ligament being spiraled in the reel.
